(19) United States
(12) Patent Application Publication
(10) Pub. No.: US 2011/0208632 A1
(43) Pub. Date: Aug. 25, 2011

(54) Generation of a Hedgeable Index and Market Making for a Hedgeable Index-Based Financial Instrument

(75) Inventors: John Labuszewski, Westmont, IL (US); Steve Youngren, Elgin, IL (US); David Lehman, Oak Park, IL (US)

(73) Assignee: CHICAGO MERCANTILE EXCHANGE INC., Chicago, IL (US)

(21) Appl. No.: 12/708,703

(22) Filed: Feb. 19, 2010

(51) Int. Cl. G06Q 40/00

(52) U.S. Cl. 705/37; 705/35

(57) ABSTRACT

Systems, methods, and apparatuses are provided for processing a relationship metric comprising a plurality of components each having an associated percentage weight, selecting a plurality of financial instruments each corresponding to one of the plurality of components, determining an integer number of each of the plurality of financial instruments such that a relationship based on the integer numbers approximates the percentage weights, and composing an index that includes the respective integer numbers of each of the plurality of financial instruments.

### DESCRIPTION OF THE RELATED ART

Foreign currency indexes have been used for a variety of purposes, such as aids in analyzing the price competitiveness of domestic goods relative to foreign goods, the effect of foreign economic and financial development on the domestic price level, and the demand for domestic and foreign currency assets. Conventional indexes have included weighted formulas that are functions of exchange rates.

The well-known G-10 (Group of Ten) index maintained by the Board of Governors of the U.S. Federal Reserve System was designed principally to measure competitiveness in world markets. The G-10 index is a function of six currency values and corresponding weights. The weights were fixed in 1976 and have not been adjusted to reflect current conditions.

The Board of Governors of the U.S. Federal Reserve System replaced the G-10 index with a set of new indexes, including the Major Currency Index. The Major Currency Index was designed principally to measure competitiveness in world markets and to serve as a gauge of financial pressures on the U.S. dollar. The index uses weights that are aggregates of three sub-measures: competition between the goods of the U.S. and country k in the U.S.; competition between the goods of the U.S. and country k in the home market of country k; and competition between the goods of the U.S. and country k in the markets of third countries. The relative weights are typically calculated annually by the Board of Governors of the U.S. Federal Reserve System.

### SUMMARY OF EXAMPLE EMBODIMENTS

The following presents a simplified summary in order to provide a basic understanding of some aspects of at least some example embodiments. The summary is not an extensive overview. It is neither intended to identify key or critical elements nor to delineate the claim scope. The following summary merely presents some concepts in a simplified form as a prelude to the more detailed description below.

Example aspects of the present disclosure provide for systems, methods, and/or apparatuses for creating a hedgeable index based on an integer number of underlying financial instruments.

Example aspects of the present disclosure also provide for market making using a hedgeable index-based financial instrument that reduces or eliminates risk incurred by a market maker.

In an example embodiment of the disclosure, systems, methods, and/or apparatuses may include processing a relationship metric comprising a plurality of components each having an associated percentage weight, selecting a plurality of financial instruments each corresponding to one of the plurality of components, determining an integer number of each of the plurality of financial instruments such that a relationship based on the integer numbers approximates the percentage weights, and composing an index that includes the respective integer numbers of each of the plurality of financial instruments.

In another example embodiment of the disclosure systems, methods, and/or apparatuses may include receiving bids and offers for an index-based financial instrument that is based on integer numbers of a plurality of underlying financial instruments, processing an order for a first position in the index-based financial instrument, matching the order with a second position that is inverse to the first position using the integer numbers of the plurality of underlying financial instruments, and executing the order by obtaining the first position and the second position.

The example embodiments of the present disclosure can be partially or wholly implemented on a computer-readable medium, for example, by storing computer-executable instructions or modules, or by utilizing computer-readable data structures that when executed, cause a system, apparatus, processor, or other device to perform any of the methods and functions described herein.

Of course, the methods and systems of the above-referenced embodiments may also include other additional elements, steps, computer-executable instructions, or computer-readable data structures. The details of these and other embodiments of the present disclosure are set forth in the accompanying drawings and the description below. Other features and advantages of the disclosure will be apparent from the description and drawings, and from the claims.

### BRIEF DESCRIPTION OF THE DRAWINGS

The present disclosure may take physical form in certain parts and steps, embodiments of which will be described in detail in the following description and illustrated in the accompanying drawings that form a part hereof, wherein:

FIG. 1 shows an example computer network system.

FIG. 2 illustrates an example of a hedgeable index created based on an integer number of underlying financial instruments to approximate a relationship metric.

FIG. 3 illustrates an example flow diagram of a method for creating a hedgeable index based on an integer number of underlying financial instruments to approximate a relationship metric.

FIG. 4 illustrates an example flow diagram of a method for market making using a hedgeable index-based financial instrument.

### DETAILED DESCRIPTION OF THE EXAMPLE EMBODIMENTS

Aspects of the present disclosure may be implemented with computer devices and computer networks that allow users to exchange trading information. In particular, a trading network environment may be used to exchange and match bids and offers for the disclosed financial instruments. A financial instrument may be, for example, one or more futures contracts, over-the-counter (OTC) derivatives, exchange trade funds (ETFs), credit default swaps, options, stocks, bonds, cash instruments, derivative instruments, evidence of an ownership interest in an entity, contractual rights to receive or deliver cash or another financial instrument, other documents representing an agreement involving a monetary value, and/or any combination thereof.

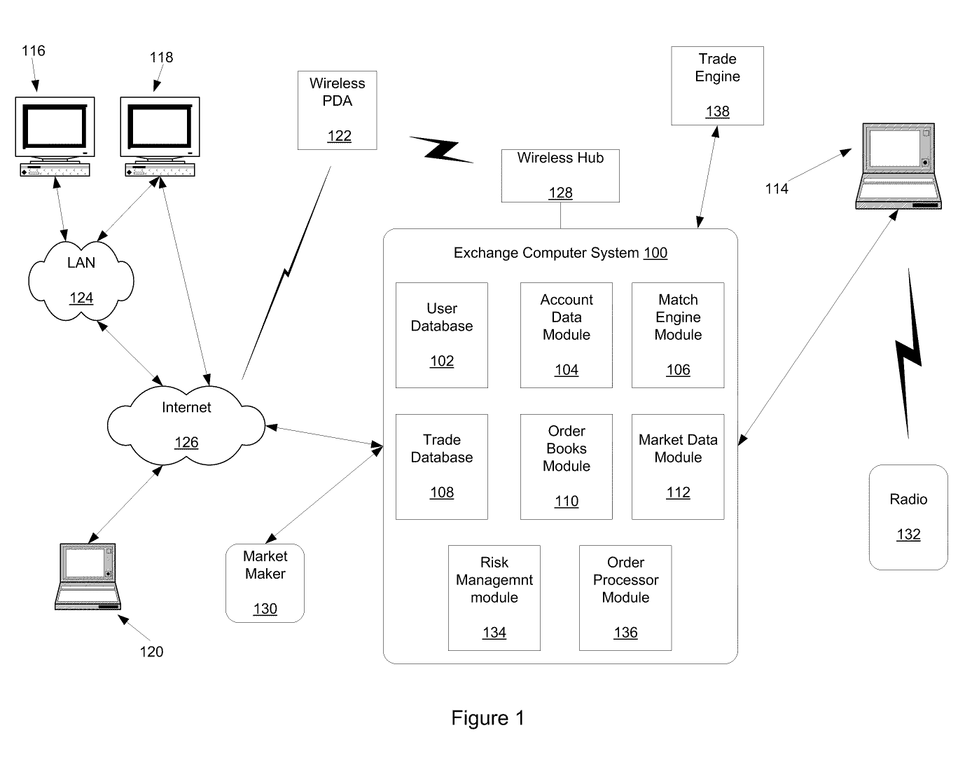

An exemplary trading network environment for implementing trading systems and methods is shown in FIG. 1. An exchange computer system 100 receives orders and transmits market data related to orders and trades to users. Exchange computer system 100 may be implemented with one or more mainframe, desktop or other computers. A user database 102 includes information identifying traders and other users of exchange computer system 100. Data may include user names and passwords. An account data module 104 may process account information that may be used during trades. A match engine module 106 is included to match bid and offer prices. Match engine module 106 may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processing module 136 may be included to process orders for further processing by order book module 110 and match engine module 106.

The trading network environment shown in FIG. 1 includes computer devices 114, 116, 118, 120 and 122. Each computer device includes a central processor that controls the overall operation of the computer and a system bus that connects the central processor to one or more conventional components, such as a network card or modem. The processors may be, for example, application specific integrated circuits (ASICs), general purpose microprocessors, or other processing devices. Each computer device may also include a variety of interface units and drives for reading and writing data or files. Depending on the type of computer device, a user can interact with the computer with a keyboard, pointing device, microphone, pen device or other input device.

Computer device 114 is shown connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

One or more market makers 130 may include a computer system having a processor and a memory storing instructions that, when executed, cause the computer system to maintain a market that provides bid and offer prices for a derivative or security to exchange computer system 100. Exchange computer system 100 may also have a processor and a memory storing executable-instructions to exchange information with other trade engines, such as trade engine 138. One skilled in the art will appreciate that numerous additional computers and systems may be coupled to exchange computer system 100. Such computers and systems may include clearing, regulatory and fee systems.

The operations of computer devices and systems shown in FIG. 1 may be controlled by computer-executable instructions stored on computer-readable medium. For example, computer device 116 may include computer-executable instructions for receiving order information from a user and transmitting that order information to exchange computer system 100. In another example, computer device 118 may include computer-executable instructions for receiving market data from exchange computer system 100 and displaying that information to a user.

Examples of computer readable media include hard drives, random access memory (RAM), read only memory (ROM), floppy disks, electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by a computer processor.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

Known indexes are made up of multiple underlying financial instruments or commodities in various percentage weights. These percentage weights are typically determined empirically to reflect economic realities. For example, percentage weights of a given instrument in an index may reflect the competitiveness of a U.S. product in a foreign market. In another example, the percentage weights in an index may reflect the competition between the goods of a first and a second country corresponding to the foreign currency in the markets of third countries. Also, percentage weights in an index may be used to reflect worldwide production values of a commodity.

A market maker 130 seeking to establish a market for trading of a financial instrument based on a conventional index, however, cannot precisely hedge risk by taking an inverse position (e.g., equal and opposite) in the same proportion of financial instruments underlying the conventional index. For example, the conventional index may be the Chicago Mercantile Exchange dollar index (CME$INDEX) that assigns percentage weights to currencies of different countries to capture the effect of global competition and are based on a set of competitive weights published by the U.S. Federal Reserve. For 2009, Table 1 below lists the currencies and their percentage weights that make up the CME$INDEX:

TABLE 1

| Currency | Percentage Weight |
|---|---|
| Euro | 45.2840% |
| Yen | 22.1649% |
| U.K. Pound | 14.5479% |
| Swiss Franc | 5.9359% |
| Australian dollar | 4.1163% |
| Canadian dollar | 3.6097% |
| Sweden Krona | 4.3413% |

A market maker 130 desiring to set up a market for a financial instrument based on the CME$INDEX is unable to take an equal and opposite position in a combination of a Euro/dollar futures contract, a Japanese Yen futures contract, a U.K. Pound futures contract, a Swiss Franc futures contract, an Australian dollar futures contract, a Canadian dollar futures contract, and a Swedish Krona futures contract in the same ratio as the percentage weights of the CME$INDEX. Rather, to create a precise hedge, the market maker 130 would have to use a fractional number of the underlying future contracts to have the same percentage weights found in the conventional index (e.g., CME$INDEX).

Because some financial instruments, for example futures contracts, are only available in integer numbers, the market maker 130 executing an order for a financial instrument based on a conventional index would have to round up or down to an integer number of underlying financial instruments to attempt to offset the risk. For instance, the market maker 130 may desire to create a CME$INDEX-based futures contract that is based on multiple underlying futures contracts for the Euro, Yen, U.K. Pound, a Swiss Franc, Australian dollar, Canadian dollar, and Swedish Krona. To precisely lay off the risk when executing an order for a CME$INDEX-based futures contract, the market maker 130 would have to take an equal and opposing position in a fractional number of one or more of the underlying futures contracts (e.g., 3.75 Euro/dollar futures contracts). As one cannot buy or sell a fractional amount of a futures contract, the market maker 130 would have to round to the next closest integer number of futures contracts (e.g., 4 Euro/dollar futures contracts) to execute the order. Rounding causes the hedge to be imprecise and is referred to as a tail risk. Thus, the market maker 130 cannot engage in market making for futures contracts based on conventional indices without incurring tail risks. Market makers 130, however, are often unwilling to take on such risks. Tail risks thus limit the usefulness of conventional indices as a basis for an indexed-based financial instrument as many market markers 130 are not interested in taking on risk when executing trades.

Creation of a hedgeable index 206 in accordance with example embodiments of the present disclosure permits market makers 130 to set up trading of a hedgeable index-based financial instrument that can be hedged with minimal or no tail risk. In an example embodiment, the hedgeable index 206 may be composed of integer numbers of respective underlying financial instruments that approximate their proportion in a relationship metric 200. For example, the hedgeable index 206 may be composed of integer numbers of respective underlying financial instruments to that approximate their proportion in the CME$INDEX. When executing an order for a hedgeable index-based financial instrument, the market maker 130 may take an inverse position in the integer numbers of underlying financial instruments to lay off the risk.

It is noted that the relationship metric 200 may be based on percentages of a single type of financial instrument (e.g., all futures contracts), or based on percentages of two or more different types of financial instruments (e.g., any combination of futures contracts, options, stocks, bonds, etc.).

In a simple example, the hedgeable index 206 may approximate a conventional index that permits a trader to hedge U.S. dollar risk against a basket of world currencies including the Euro and Japanese Yen. The hedgeable index 206 may be based on an integer number of Euro/dollar and Japanese Yen futures contracts in a proportion that approximates their percentage weights in the conventional index. The market maker 130 may receive an order to take a long or short position in a hedgeable index-based financial instrument. To execute the order, the market maker 130 may take an opposing position in an integer number of Euro/dollar and Japanese Yen futures contracts to execute the trade, thus incurring minimal or no undesired risk to execute the transaction. Creation of the hedgeable index 206 and market making using a hedgeable index-based financial instrument are further discussed below.

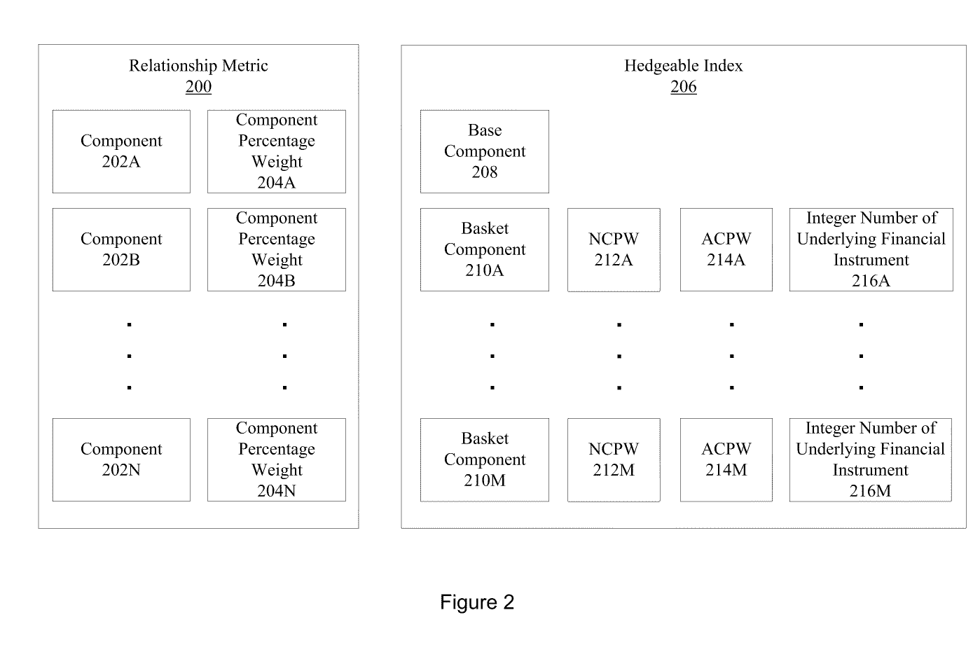

FIG. 2 illustrates an example of a hedgeable index 206 created based on integer numbers of underlying financial instruments to approximate component percentage weights (CPW) 204 of components 202 in a relationship metric 200. In an example embodiment, the relationship metric 200 may be composed of components 202 in various component percentage weights 204. Components 202 may be, for example, currencies of different countries, different types of commodities, shares of stock from one or more companies, one or more types of bonds, other tradable instruments, and/or any combination thereof. Examples of relationship metrics 200 may include a conventional index (e.g., Standard & Poors Goldman Sachs Commodities Index, CME$INDEX, etc.), a mutual fund, competitiveness statistics, or other metrics on multiple financial instruments indicating a percentage weight of each instrument in the metric.

The exchange computer system 100 may process the relationship metric 200 to create the hedgeable index 206 based on integer numbers of financial instruments for the components 202. In an example embodiment, the exchange computer system 100 may use statistics from the Bank for International (BIS) as the relationship metric 200. The BIS statistics may identify percentages of foreign exchange (FX) derivatives that include a base currency (e.g., U.S. dollar) on one side or the other. A recent survey from the BIS suggests that FX derivatives include the following seven currencies on one side or the other in the following percentages: 43.96% include U.S. dollars, 19.83% include Euros (EUR), 8.48% include Japanese yen (JPY), 6.74% include Pounds sterling (GBP), 3.13% include Swiss francs (CHF), 2.07% include Canadian dollars (CAD), and 1.53% include Australian dollars (AUD). Thus, 85.75% of all FX derivatives include one of these seven currencies on one side or the other.

In another example embodiment, the component percentage weights 204 may be the competitiveness weights published by the Federal Reserve and used to calculate weights used of the Major Currency Index. The Federal Reserve typically publishes revised competitive weights in the beginning of the calendar year. The competitive weights may be adjusted on the first trading day in March of every year to provide additional transparency in calculating the value of a financial instrument.

The exchange computer system 100 may use some or all of the components 202 from the relationship metric 200 to create the hedgeable index 206. In an example, an exchange may determine that there is sufficient trader demand desiring to offset risk in U.S. dollar-based positions against a basket of other world currencies. The exchange computer system 100 may receive an input specifying a component 202A of the relationship metric 200 as being a base component 208 and one or more of components 202B-202N as being basket components 210. The base component 208 may refer to the currency, commodity, or other financial instrument for which a trader or other entity desires to reduce their risk exposure due to changes in the value of the base component 208. The basket components 210 may refer to a group of currencies, commodities, or other financial instruments used to diversify the risk of the value fluctuations of the base component 208. For example, the U.S. dollar may be the base component 208 and each of the Euro, Japanese yen, Pounds sterling, Swiss francs, Canadian dollars, and Australian dollars may be the basket components 210A-210M.

The exchange computer system 100 may also automatically select some or all of the components 202 of the relationship metric 200 as the basket components 210. For example, the exchange computer system 100 may establish a percentage threshold (e.g., 5%) and only use components 202 from the relationship metric 200 having component percentage weights 204 that are greater than a certain percentage weight of the relationship metric 200 as the basket components 210.

The exchange computer system 100 may also require a certain amount of liquidity of financial instruments for the components 202 for selection as a basket component 210. For example, futures contracts for the components 202 that trade infrequently may not be suitable for market making as they would limit the market maker's ability to rapidly match a trader's order request against an offsetting position.

Of course additional or alternative currencies may be used as the base component 208. For example, the base component 208 may be one of the European Union euro, the Australian dollar, the Canadian dollar, the Japanese yen, the Swedish krona, the Swiss franc, and the United Kingdom pound. In yet another embodiment, all 27 currencies for which the Board of Governors of the U.S. Federal Reserve System calculates trade weights may be used. Different financial instruments may be created by using any one of the 27 currencies as a base currency. Thus, any currency potentially may be used as the base component 208 or as the basket components 210. Further, the base component 208 may be other types of financial instruments instead of currencies.

If less than all of the components 202 of the relationship metric 200 are selected as being basket components 210, the exchange computer system 100 may normalize the component percentage weights 204 so that the normalized percentage weights for the selected basket components 210 sum to 100. Below is an example table listing components 202, their CPW 204, and their normalized component percentage weight (NCPW) 212. In an example provided in table 2 below, the U.S. dollar is the base component 208, and the Euro, Japanese yen, Pounds sterling, Swiss francs, Canadian dollars, and Australian dollars are the basket components 210A-210M. The sum of the CPWs 204 of the basket components 210 using the BIS statistics in Table 2 is 41.79%. The NPCW 212 for the Euro is 47.4% (i.e., 19.83%/41.79%), for the Yen is 20.3 (i.e., 8.48%/41.79%), and so forth, as shown below.

TABLE 2

| Component | CPW (%) | NCPW (%) |
|---|---|---|
| 202 | 204 | 212 |
| USD | 43.96% | — |
| EUR | 19.83% | 47.4% |
| JPY | 8.48% | 20.3% |
| GBP | 6.74% | 16.1% |
| CHF | 3.13% | 7.5% |
| CAD | 2.07% | 5.0% |
| AUD | 1.53% | 3.7% |

If all of the components 202 of the relationship metric 200 are used as basket components 210, then the CPW 204 is the same as the NCPW 212. Also, normalization may be applied to approximated component percentage weights (ACPW) 214 rather than to the CPWs 204.

The exchange computer system 100 may then determine ACPWs 214 to approximate the NCPW 212 based on integer numbers of financial instruments 216 for each of the basket components 210. The exchange computer system 100 may determine an integer number for each financial instrument such that the proportion of the value of the hedgeable index 206 attributable to the respective basket components 210 approximates the NCPW 212A-212M.

The exchange computer system 100 may also apply constraints when generating the ACPWs 214 to limit the total integer number of financial instruments underlying the hedgeable index 206 (e.g., 11 or fewer underlying futures contracts), to limit a difference between the NCPW 212 and the ACPW 214, and/or to limit a total value of the hedgeable index 206. As such, each ACPW 214 may not precisely correspond to its corresponding NCPW 212, but generating the hedgeable index 206 in this manner advantageously permits precise hedging by a market maker 130 using integer numbers of financial instruments.

In an example, the hedgeable index 206 may be composed of integer numbers of financial instruments that are futures contracts. In this example, the ACPWs 214 may be a function of a futures contract size and spot price for futures contracts for each of the basket components 210. The contract size may be a fixed number established by a rulebook of the exchange computer system 100 for each type of futures contract. For example, the exchange may specify that Euro/dollar futures contracts trade in increments of 125,000 Euro. The spot price may reflect a current market price of a basket component 210 relative to the base component 208. For example, the spot price of a Euro/dollar futures contract may be 1.283 Euros per U.S. dollar.

To determine the ACPWs 214 for each of the basket components 210A-210M, the exchange computer system 100 may solve the following equation based on constraints on the total integer number of futures contracts, a maximum value of underlying futures contracts, and/or a maximum permitted difference ‘x’ between NCPW 212 and ACPW 214 for any one futures contract (e.g., |ACPWᵢ−CPWᵢ|<xᵢ):

$$\vert {ACPW}_{i} - {CPW}_{i} \vert = \vert \frac{{Contract\_value}_{i} * Int\_Number {\_contracts}_{i}}{{\sum }_{j = 1}^{m} {Contract\_value}_{j} * Int\_Number {\_contracts}_{j}} - {CPW}_{i} \vert \leq {x}_{i}$$

Where i={1, 2, . . . M}, M is the number of basket components 210), and the contract_valueᵢ=spot_priceᵢ*contract_sizeᵢ. Thus, all variables in the above equation are known other than the Int_Number_contracts for each of the basket components 210, and the exchange computer system 100 may then determine the integer number of futures contracts Int_Number_contracts based on the above equation subject to the above constraints.

For example, using the BIS statistics and the rulebook, the exchange computer system 100 may solve the above equation to compose a hedgeable index 206 based on the following integer numbers of the underlying financial instruments: 4 Euro/dollar futures contracts, 2 Japanese yen futures contracts, 2 Pounds sterling (GBP) futures contracts, 1 Swiss francs (CHF) futures contract, 1 Canadian dollars (CAD) futures contract, and 1 Australian dollars (AUD) futures contract. Table 3 below illustrates a relationship between the contract size, spot price, contract value, integer number of contracts, the approximated component weight in dollars, and the ACPW 214 and the NCPW 212 for each of the basket components 210.

TABLE 3

| Basket | | | | Integer | Approximated | | |
|---|---|---|---|---|---|---|---|
| component | Contract | Spot | Contract | Numbers of | Component Weight | ACPW | NCPW |
| 210 | Size | Price | Value | Contracts | ($) | (%) | (%) |
| EUR | 125,000 | 1.283 | $160,375 | 4 | $641,500 | 47.9% | 47.4% |
| JPY | 12,500,000 | 0.0104 | $130,000 | 2 | $260,000 | 19.4% | 20.3% |
| GBP | 62,500 | 1.5104 | $94,400 | 2 | $188,800 | 14.1% | 16.1% |
| CHF | 125,000 | 0.8328 | $104,100 | 1 | $104,100 | 7.8% | 7.5% |
| CAD | 100,000 | 0.8097 | $80,970 | 1 | $80,970 | 6.0% | 5.0% |
| AUD | 100,000 | 0.6453 | $64,530 | 1 | $64,530 | 4.8% | 3.7% |

| | |
|---|---|
| Basket Value | $1,339,900 |

Using the above table, the contract value of a Euro/dollar futures contract is 125,000*1.283=$160,375. The integer number of financial instruments is 4 futures contracts, thus the approximated component weight is 4*$160,375=$641,500. The approximated component percentage weight is $641,500/$1,399,900=47.9%.

In an example, there is an inverse relationship between the value of the dollar and of the hedgeable index 206. As the U.S. dollar strengthens (weakens), foreign currencies become cheaper (more expensive) quoted in US dollars.

In Table 3 above, the basket value may be a total value of the underlying financial instruments included in the hedgeable index 206, which is $1,399,900 U.S. dollars in the above example. The basket value may be the same as the value of the hedgeable index 206, or the value of the hedgeable index 206 may be the basket value divided by a predetermined number (e.g., 10,000) to reduce its size.

Once created, the exchange computer system 100 may inform market makers 130 of the value of the hedgeable index 206 and the integer number and type of underlying financial instruments (e.g., 4 Euro/dollars futures contracts, 2 Japanese Yen futures contracts, etc.). The market maker 130 may then provide quotes for a hedgeable index-based financial instrument that is based on integer numbers of each of the underlying financial instruments. In an example, the market maker 130 may publish to traders a fact sheet similar to that shown in Table 4.

TABLE 4

| | |
|---|---|
| Contract Size | $1,000 × Index, e.g., if Index = 133.99 then |
| | futures contract value = $133,990 (= $1,000 × 133.99) |
| Tick Size | 0.01 index points ($10.00) |
| Index | Index valued at spot value of a component “basket” composed of 4 EuroFX + 2 Japanese |
| Construction | yen + 2 British pound + 1 Swiss franc + 1 Canadian dollar + 1 Australian dollar futures |
| | contracts; all divided by $10,000 |
| Trade Ends @ | 9:16 am (CT) on 2^{nd} business day immediately preceding 3^{rd} Wednesday of contract month |
| Cash Settlement | All open positions on termination of trading are cash settled based upon a quotation of Index |
| to Final | utilizing final settlement prices at termination of trade for CME FX futures with exception of |
| Settlement | Canadian dollar where a special 9:16 value is utilized noting that Canadian dollar terminates |
| Prices | a day later. These settlement prices are entered into the INDEX formula using the index |
| | construction methodology as described. |
| Trading Hours | Sundays through Fridays: 5:00 p.m.-4:00 p.m. Central time (CT) the next day. On Friday |
| | Trading platform closes at 4:00 p.m. and reopens Sunday at 5:00 p.m. CT. |
| Months | Six months in the March, June, September and December quarterly cycle |
| Position | Positions of more than 6,000 contracts net long or short, in all contract months combined |
| Accountability | must provide, in a timely fashion upon request, information regarding the position |

Traders using a trading computer system may then electronically submit orders to take long or short positions in the hedgeable index-based financial instrument. The market maker 130 may then attempt to match orders for the hedgeable index-based financial instruments against the specified integer numbers of the respective underlying financial instruments.

If the value of the hedgeable index 206 is the same as the basket value, then the market maker 130 may match a long or short position on a hedgeable index-based financial instrument against an opposite position in integer numbers of the underlying financial instruments. For example, the market maker 130 may match an offer to take a long position in the hedgeable index-based financial instrument against taking a short position in 4 Euro/dollar futures contracts, 2 Japanese yen futures contracts, 2 Pounds sterling (GBP) futures contracts, 1 Swiss francs (CHF) futures contract, 1 Canadian dollars (CAD) futures contract, and 1 Australian dollars (AUD) futures contract.

If the value of the hedgeable index 206 is a fraction of the basket value (e.g., basket value divided by $10,000), then the market maker 130 may match a long or short position using an integer number of hedgeable index-based financial instruments having a value that equals the basket value. For example, a hedgeable index-based financial instrument may have a value of $133,990 (i.e., $1,339,900/$10,000). The market maker 130 may match a long or short position in 10 hedgeable index-based financial instruments against an opposite position in 4 Euro/dollar futures contracts, 2 Japanese yen futures contracts, 2 Pounds sterling (GBP) futures contracts, 1 Swiss francs (CHF) futures contract, 1 Canadian dollars (CAD) futures contract, and 1 Australian dollars (AUD) futures contract. Thus, the market maker 130 can take the opposite position and hedge against the position desired by the trader while incurring minimal or no risk when executing the trade.

The market maker 130 may also perform other functions such as listing the hedgeable index-based financial instruments for trading, and receiving and matching bids and offers for the hedgeable index-based financial instruments. Conventional settlement services for executed trades may also be performed by the market maker 130. The market maker 130 may also provide notice of matched trades to traders associated with matched bids and offers.

The exchange computer system 100 may create a hedgeable index 206 based on other types of relationship metrics 200. In an example, an exchange may identify trader demand to offset their U.S. dollar-based positions against a basket of commodities, rather than a basket of currencies. The example below describes creating a hedgeable index 206 based on relationship metric 200 that is a commodities index, such as, but not limited to, the Standard & Poor's (S&P) Goldman Sachs Commodity Index (GSCI), where the components 202 are commodities. The S&P GSCI may be roughly weighted to reflect world production values of certain commodities. Example commodities may include Crude Oil, Gas, Heating Oil, Gold, Silver, Wheat, Corn, Soybeans, Live Cattle, Feeder Cattle, Lean Hogs, etc.

The exchange computer system 100 may select some or all of the components 202 from the S&P GSCI as the basket components 210, in the manner described above, and a currency (e.g., U.S. dollar) may be used as the base component 208. The exchange computer system 100 also may perform any normalization of the component percentage weights 204, as discussed above.

The exchange computer system 100 may then determine ACPWs 214 that approximate the NCPWs 212 based on integer numbers of financial instruments 216 for the basket components 210. Table 5 below provides example data for a hedgeable index 206 based on integer numbers of underlying commodity futures contracts.

TABLE 5

| | | | | Integer | | |
|---|---|---|---|---|---|---|
| | Contract | | Contract | Numbers of | Weight | ACPW |
| | Size | Price | Value | Contracts | Amount ($) | (%) |
| WTI Crude Oil | 1,000 | 71.08 | $71,080 | 12 | $852,960 | 54.19% |
| RBOB Gas | 40,000 | 2.0242 | $80,968 | 1 | $80,968 | 5.14% |
| Heating Oil | 40,000 | 1.9273 | $77,092 | 1 | $77,092 | 4.90% |
| Natural Gas | 10,000 | 4.037 | $40,370 | 2 | $80,740 | 5.13% |
| Gold | 100 | 966.4 | $96,640 | 1 | $96,640 | 6.14% |
| Silver | 5,000 | 14.735 | $73,675 | 1 | $73,675 | 4.68% |
| Wheat | 5,000 | 5.5325 | $27,663 | 3 | $82,988 | 5.27% |
| Corn | 5,000 | 3.525 | $17,625 | 4 | $70,500 | 4.48% |
| Soybeans | 5,000 | 10.35 | $51,750 | 1 | $51,750 | 3.29% |
| Live Cattle | 40,000 | 0.8975 | $35,900 | 1 | $35,900 | 2.28% |
| Feeder Cattle | 50,000 | 1.0125 | $50,625 | 1 | $50,625 | 3.22% |
| Lean Hogs | 40,000 | 0.50225 | $20,090 | 1 | $20,090 | 1.28% |

| | |
|---|---|
| Basket Value | $1,573,928 |

Hedgeable Index Value = Basket Value ÷ $10,000 = $1,573,928 ÷ $10,000 = 157.39

In this example, the value of the hedgeable index 206 may be the basket value divided by $10,000. Market makers 130 may then set up trading of the hedgeable index-based financial instruments. In an example, the market maker 130 may publish to traders a fact sheet similar to that shown below in Table 6.

TABLE 6

| | |
|---|---|
| Contract Size | $200 × Index, e.g., if Index = 157.39 then |
| | futures contract value = $31,478 (= $200 × 157.39) |
| Tick Size | 0.10 index points ($20.00) |
| Index | Index valued by reference to a “basket” composed of 12 WTI Crude Oil; 1 RBOB Gas; 1 |
| Construction | Heating Oil; 2 Natural Gas; 1 Gold; 1 Silver; 3 Wheat; 4 Corn; 1 Soybeans; 1 Live |
| | Cattle; 1 Feeder Cattle and 1 Lean Hog futures contracts as traded on CME Group |
| | facilities; all divided by $10,000 |
| Termination | Trading terminates on the 11^{th} business day of the month |
| Cash | All open positions on termination of trading are cash based upon a Special Quotation of |
| Settlement | Index utilizing nearby contract month price of Index components. The Index is |
| | constructed using index construction methodology as described. |
| Trading Hours | ? |
| Months | All twelve (12) contract months of the year |
| Position Limits | 10,000 contracts net long or short, in all contract months combined |

In this example, the hedgeable index-based financial instruments may be cash settled based on the value of the hedgeable index 206 using nearby contract months, all multiplied by $200. Market makers 130 and arbitrageurs may precisely hedge by matching off hedgeable index-based financial instruments by taking offsetting positions in futures contracts for the twelve basket components 210 (i.e., WTI crude oil, RBOB gas, etc.).

If the value of the hedgeable index 206 is the same as the basket value, then the market maker 130 may match an order for a long or short position on a hedgeable index-based financial instruments against an opposite position using the underlying commodities futures contracts. For example, the market maker 130 may match an offer to take a long position in the hedgeable index-based financial instrument against taking a short position in 12 West Texas Intermediate (WTI) Crude Oil futures contracts, 1 Reformulated Gasoline Blendstock for Oxygen Blending (RBOB) gas futures contract, 1 heating oil futures contract, 2 natural gas futures contracts, 1 gold futures contract, 1 silver futures contract, 3 wheat futures contracts, 4 corn futures contracts, 1 soybeans futures contract, 1 live cattle futures contract, 1 feeder cattle futures contract, and 1 lean hogs futures contract. If the value of the hedgeable index 206 is a fraction of the basket value, then the market maker 130 may match a long or short position on multiple hedgeable index-based financial instruments having the same value as the basket value. Thus, the market maker 130 can take the opposite position and precisely hedge against the position desired by the trader.

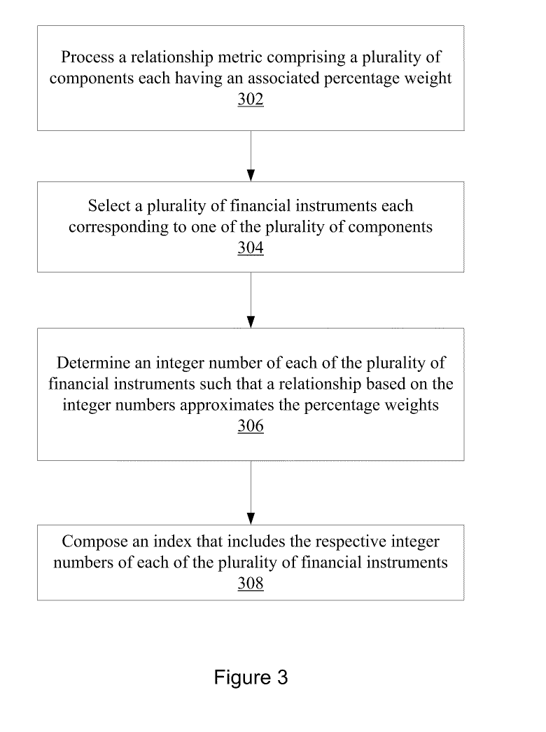

FIG. 3 illustrates an example flow diagram of a method for creating a hedgeable index 206 to approximate a relationship metric 200. In an example, the method may be implemented by the exchange computer system 100. The flow diagram may begin at block 302.

In block 302, the method may include processing a relationship metric 200 comprising a plurality of components 202 each having an associated percentage weight 204. In block 304, the method may include selecting a plurality of financial instruments each corresponding to one of the plurality of components 202. In block 306, the method may include determining an integer number of each of the plurality of financial instruments such that a relationship based on the integer numbers of the financial instruments approximates the percentage weights 204. In block 308, the method may include composing a hedgeable index 206 that includes the respective integer numbers of each of the plurality of financial instruments.

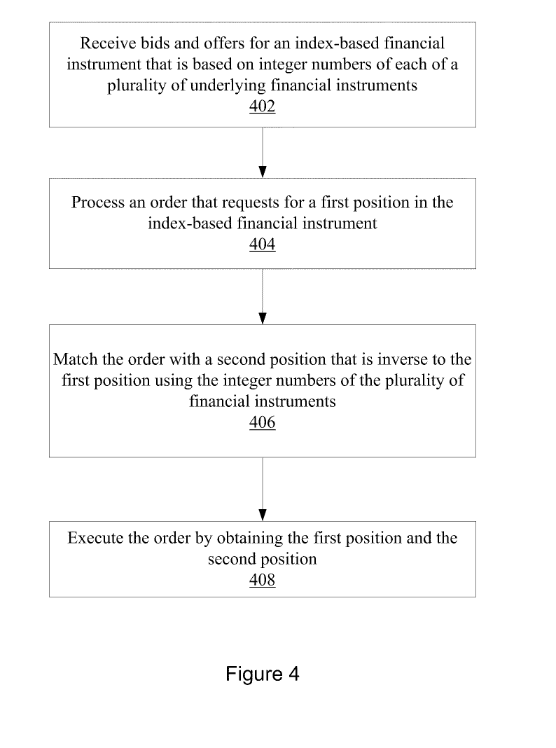

FIG. 4 illustrates an example flow diagram of a method for market making using a hedgeable index-based financial instrument. In an example, the method may be implemented by the market maker 130. The flow diagram may begin at block 402.

In block 402, the method may include receiving bids and offers for a hedgeable index-based financial instrument that is based on integer numbers of each of a plurality of financial instruments. In block 404, the method may include processing an order that requests to obtain a first position in the hedgeable index-based financial instrument. In block 406, the method may include matching the order with a second position that is inverse to the first position using the integer numbers of each of the plurality of financial instruments. In block 408, the method may include executing the order by obtaining the first position and the second position.

The above examples describe composing an index based on underlying financial instruments that may be futures contracts. The underlying financial instruments also may be other types of financial instruments, such as, but not limited to, options, bonds, stocks, etc. Moreover, the underlying financial instruments may be of different types, such as, but not limited to, any combination of two or more of stocks, bonds, futures contracts, options, or other financial instrument types.

The present disclosure has been described herein with reference to specific exemplary embodiments thereof. It will be apparent to those skilled in the art, that a person understanding this disclosure may conceive of changes or other embodiments or variations, which utilize the principles of this disclosure without departing from the broader spirit and scope of the disclosure as set forth in the appended claims. All are considered within the sphere, spirit, and scope of the disclosure.

What is claimed is:

1. A method comprising:
processing a relationship metric comprising a plurality of components each having an associated percentage weight;
selecting a plurality of financial instruments each corresponding to one of the plurality of components;
determining, by a processor, an integer number of each of the plurality of financial instruments such that a relationship based on the integer numbers approximates the percentage weights; and
composing an index that includes the respective integer numbers of each of the plurality of financial instruments.

2. The method of claim 1, wherein each of the financial instruments is a futures contract having a contract size and a spot price.

3. The method of claim 2, wherein the relationship is based on respectively multiplying the integer numbers by the contract sizes and the spot prices to determine approximate weights, and dividing each approximate weight by a sum of the approximate weights to determine approximate percentage weights that respectively approximate the percentage weights.

4. The method of claim 3, wherein the determining of the integer number of each of the plurality of financial instruments is subject to a constraint that limits an amount of difference between the approximate percentage weights and the percentage weights.

5. The method of claim 1, wherein the determining of the integer number of each of the plurality of financial instruments is subject to a constraint that limits a total number of the plurality of financial instruments.

6. The method of claim 1, further comprising:
receiving bids and offers for an index-based financial instrument that is based on the index;
processing an order for a first position in the index-based financial instrument;
matching the order with a second position that is inverse to the first position using the integer numbers of each of the plurality of financial instruments; and
executing the order by obtaining the first position and the second position.

7. The method of claim 1, wherein the financial instruments are futures contracts for different types of commodities.

8. The method of claim 1, wherein the financial instruments are futures contracts for different types of currencies.

9. An apparatus comprising:
a processor; and
a memory storing instructions that, when executed, cause the apparatus to perform at least operations comprising:
processing a relationship metric comprising a plurality of components each having an associated percentage weight;
selecting a plurality of financial instruments each corresponding to one of the plurality of components;
determining an integer number of each of the plurality of financial instruments such that a relationship based on the integer numbers approximates the percentage weights; and
composing an index that includes the respective integer numbers of each of the plurality of financial instruments.

10. The apparatus of claim 9, wherein each of the financial instruments is a futures contract having a contract size and a spot price.

11. The apparatus of claim 10, wherein the relationship is based on respectively multiplying the integer numbers by the contract sizes and the spot prices to determine approximate weights, and dividing each approximate weight by a sum of the approximate weights to determine approximate percentage weights that respectively approximate the percentage weights.

12. The apparatus of claim 11, wherein the determining of the integer number of each of the plurality of financial instruments is subject to a constraint that limits an amount of difference between the approximate percentage weights and the percentage weights.

13. The apparatus of claim 9, wherein the determining of the integer number of each of the plurality of financial instruments is subject to a constraint that limits a total number of the plurality of financial instruments.

14. The apparatus of claim 9, wherein the instructions, when executed, further cause the apparatus to perform:
receiving bids and offers for an index-based financial instrument that is based on the index;
processing an order for a first position in the index-based financial instrument;
matching the order with a second position that is inverse to the first position using the integer numbers of each of the plurality of financial instruments; and
executing the order by obtaining the first position and the second position.

15. A computer readable medium storing instructions that, when executed, cause an apparatus to perform operations comprising:
processing a relationship metric comprising a plurality of components each having an associated percentage weight;
selecting a plurality of financial instruments each corresponding to one of the plurality of components;
determining an integer number of each of the plurality of financial instruments such that a relationship based on the integer numbers approximates the percentage weights; and
composing an index that includes the respective integer numbers of each of the plurality of financial instruments.

16. The computer readable medium of claim 15, wherein each of the financial instruments is a futures contract having a contract size and a spot price.

17. The computer readable medium of claim 16, wherein the relationship is based on respectively multiplying the integer numbers by the contract sizes and the spot prices to determine approximate weights, and dividing each approximate weight by a sum of the approximate weights to determine approximate percentage weights that respectively approximate the percentage weights.

18. The computer readable medium of claim 15, wherein the determining of the integer number of each of the plurality of financial instruments is subject to a constraint that limits an amount of difference between the approximate percentage weights and the percentage weights.

19. The computer readable medium of claim 15, wherein the determining of the integer number of each of the plurality of financial instruments is subject to a constraint that limits a total number of the plurality of financial instruments.

20. The computer readable medium of claim 15, wherein the instructions, when executed, further cause the apparatus to perform:
receiving bids and offers for an index-based financial instrument that is based on the index;
processing an order for a first position in the index-based financial instrument;
matching the order with a second position that is inverse to the first position using the integer numbers of each of the plurality of financial instruments; and
executing the order by obtaining the first position and the second position.
